(19) United States
(12) Patent Application Publication
(10) Pub. No.: US 2011/0013109 A1
(43) Pub. Date: Jan. 20, 2011

(54) Solar Power Message Display For Windows

(76) Inventor: Dennis Bryan, Toronto (CA)

Correspondence Address: NASSER ASHGRIZ, 7805 Bayview Ave., # 1510, Thornhill, ON, L3T 7N1, CA

(21) Appl. No.: 12/504,710

(22) Filed: Jul. 17, 2009

(51) Int. Cl. G02F 1/1333; G02F 1/133

(52) U.S. Cl. 349/58; 349/116

(57) ABSTRACT

A LCD display device for displaying messages, announcements, pictures, logos and other expressions from the interior of a vehicle to be seen from outside. The display device utilizes miniature solar or regular batteries for cordless installation. It can be attached on a window using Velcro, suction cups or hooks. The back side of the device comprising a second display device, a notepad, a white board, a reading light, a GPS holder, or an air freshener holder.

### FIELD OF THE INVENTION

The present invention relates to a self contained digital display and advertisement systems with functional features to be installed on the windows of a vehicle or a building.

### BACKGROUND OF THE INVENTION

It has become a common practice for people to express their views, provide advertising statements, and display certain information on their vehicles, homes or commercial buildings. This is mainly achieved by using bumper stickers or stickers on the body of a vehicle or walls of a building. For instance, stickers to support the troops or stickers of the flags of a country. In addition, during sports competitions, it has become common to install the flag of a team or a country on a vehicle, showing ones support of the team or a country. Also, during election, pictures of the candidates or their names can be displayed. In such application, a low cost display system is needed to have large number of distributions.

With the development of digital electronics and availability of digital display systems in a variety of shapes and sizes with low power demand, it is now possible to have a digital display system at low cost for such application noted above. The present device makes it easy for a person to simply purchase and mount the device on the interior side of a window of a car, display a flag or any other expressions. Liquid Crystal Display (LCD) units are one such digital system which are inexpensive and low power and can display virtually anything at high resolution.

LCD systems for displaying images or announcement on windows of vehicles and building are not yet available. The display systems for such application have mainly utilized light emitting diodes (LEDs). For example, U.S. Pat. No. 4,112,876 issued to Fosnough and Nelson discloses a digital readout device to be affixed to an interior vehicle surface adjacent to the vehicle window. U.S. Pat. No. 4,264,979 issued to Gutowski discloses a CB display panel to be installed on the front dashboard or the rear window area of a vehicle. U.S. Pat. No. 4,361,828 issued to Hose discloses a digital display device using older technologies to display messages for the viewers outside of a vehicle. U.S. Pat. No. 4,574,269 issued to Miller discloses another digital display unit to be installed near the rear window of a vehicle to display messages. U.S. Pat. No. 4,949,071 issued to Hutchinson discloses a vehicle communication device mounted onto a rear shelf of a vehicle adjacent a rear window, or secured to the side window of a vehicle using suspension hooks. U.S. Pat. No. 4,974,354 issued to Hembrook discloses a visual display device for vehicles in which a plurality of messages are selectively illuminated by controls located inside the vehicle. U.S. Pat. No. 5,825,281 issued to McCreary discloses a message display device installed on the exterior surfaces of a vehicle and comes on with the automotive break lights.

The prior art display systems noted above electrical outlets of conventional batteries to power their device. Another category of display devices use solar power to illuminate the display. Examples of such devices are provided in the U.S. Pat. Nos. 4,903,172, 4,994,941, 5,007,190, 5,101,329 and 5,435,087. These patents and similar ones disclose the use of a solar cells to collect and convent the sunlight into electrical power to power the display system. Usually a battery is used to store the solar power for later use in the absence of sunlight.

The present invention is a combination of several technologies comprising of a digital display system to be mounted in the interior side of windows and to display any announcements and expressions, as well as having a functional feature is not seen in the prior art. The prior art taken either singly or in combination, is seen not to describe the instant invention as claimed.

### SUMMARY OF THE INVENTION

The present invention provides a window display system, which can be mounted on various windows of an automobile, and which also has other utilities such as a holder for a GPS systems, a notepad, or a reading light. The present invention comprises a solar power LCD display unit wherein the display unit utilizes Velcro, suction cups, or hook attachments to be mounted on a window. The Velcro and suction cup attachments can be used on any of the windows of a vehicle, such as the rear windshield or the side windows. It also comes with hooks to be hanged from the side windows or side handles of a vehicle.

It is the object of the present invention to provide a solar powered digital display device, which may be used inside a vehicle or a building to be visible from the outside and to communicate certain information with the outside world.

It is a further object of the present invention to provide a new and improved visual communication device at low cost.

These and other objects of the present invention will become readily apparent upon further review of the following specification and drawings. To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

In the figures, which illustrate, by way of example only, embodiments of the present invention,

FIG. 1 is an isometric illustration of the digital display device of the present invention showing Velcro attaching means.

FIG. 2a is an isometric illustration of the digital display device of the present invention showing places for attaching suction cups.

FIG. 2b is an isometric illustration of the back side of the display device having a notepad.

FIG. 3a is an isometric illustration of the front size of the present invention having a reading light.

FIG. 3b is an isometric illustration of the back size of the present invention having a reading light and a second display screen.

FIG. 4 is an isometric illustration of the back size of the present invention having an air freshener.

FIG. 5a is an illustration of the digital display device of the present invention attached to the side window of a car using suction cups.

FIG. 5b is an illustration of the digital display device of the present invention attached to the side window of a car using suction cups.

FIG. 6 is an isometric illustration of the digital display device of the present invention showing hooks for attaching to the side window of a vehicle.

FIG. 7 illustrates a multi-panel display unit also to be used as a shade for a vehicle.

### DETAILED DESCRIPTION OF THE INVENTION

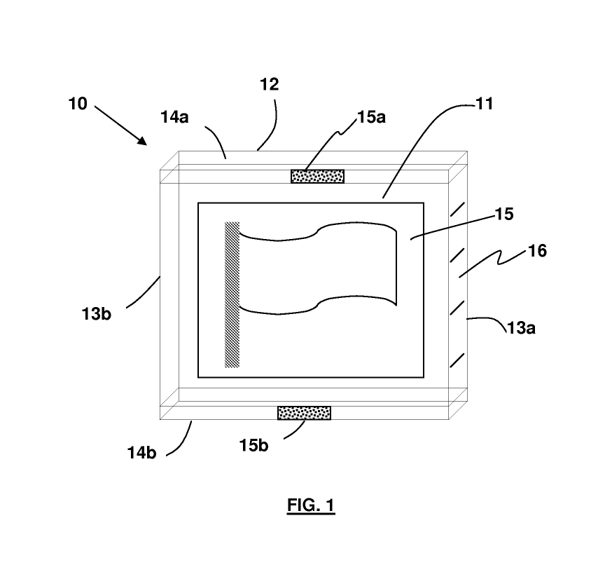

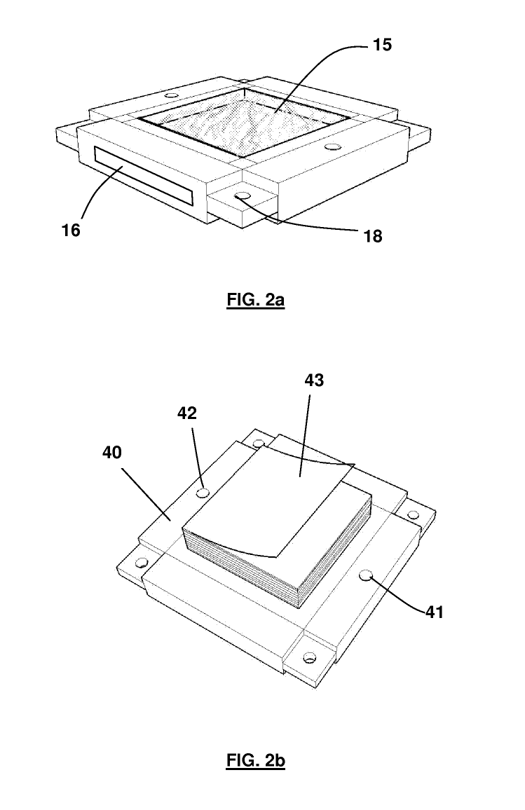

The present invention is a digital display device to be attached to the interior side of windows or windshields of a vehicle or windows of a building for displaying pictures, flags, and other expressions and information to be seen from the outside. Two different embodiments of the same invention are shown in FIGS. 1 and 2. FIG. 1 illustrates one embodiment of the digital display unit having a housing 10. The housing can be made of any material such as plastic, wood, metal, and other material capable of enclosing electronics. The device is substantially rectangular having a front face 11, a back face 12, and side faces 13a, 13b, 14a, 14b. It comes in different sizes to adapt to cover a smaller or a larger area of a window.

The front face of the device 11 contains a liquid crystal display (LCD) screen 15 which can display any programmed image. A variety of display systems with various image resolution can be used. A standard image resolution of 300 dpi can be used to provide good image qualities for window displays. The device can take variety of image formats, such as PSD/TIF/EPS/BMP/AI/JPG, etc. The device has a memory unit (not shown) that can store numerous images to be selected and displayed by a user.

The device is powered by a solar cell battery units 16 which uses solar cell arrays located on its sides 13a, 13b. The solar cells can be located on any side of the device, although FIG. 1 shows them on the right and the left sides. The operation of solar batteries is known in the art and it is not repeated here. The solar cell arrays provide a cell voltage to a series of capacitors. The cell voltage causes the storage capacitors to be charged to the capacitor voltage. A power supply regulator regulates voltage for use by the electronics of the LCD. The use of solar cells allows continuous operation of the device without requiring a battery. The device can also use other sources of power such as batteries or a power input from the vehicle lighter. The whole device is self contained and waterproof.

FIG. 2b illustrates the back side 40 of the device. The device has at least switches to change the operation mode of the system and the display signs. The device has at least two operation modes, continuous and flashing modes. In the continuous mode the image is on continuously, whereas in the flashing mode, the image operates intermittently, and flashes in certain intervals. A switch 41 on the back side of the device turns the unit on and off and changes from continues to flashing mode. Another switch 42 allows the user to change images. The device may also have means to receive digital data information, such as a USB or other types of memory input, to allow a user to input any desired image.

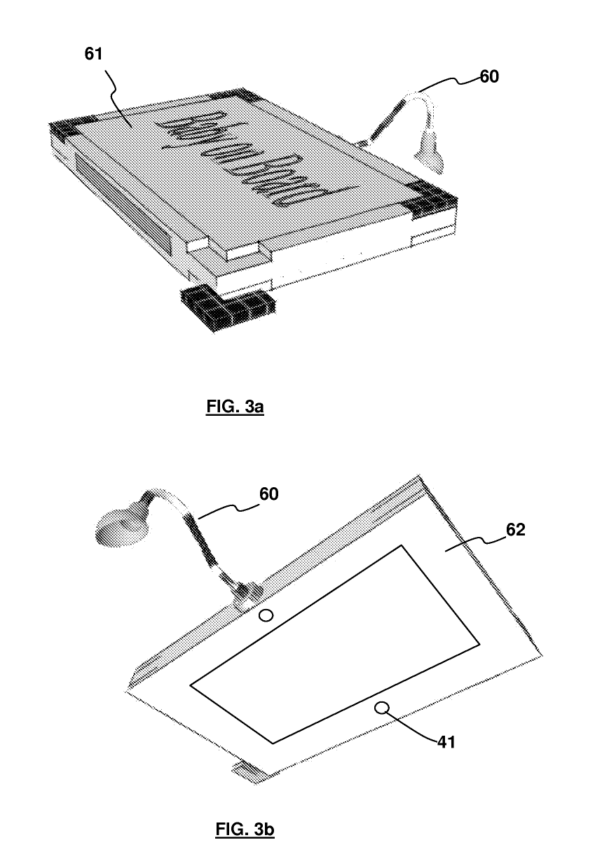

The back side of the device has various functionalities. FIG. 2b shows a notepad 43 attached to the back side of the device. This can be replaced with a white board for making notes, or a pocket for holding devices such as a GPS. The device may also have a reading light 60, as shown in FIGS. 3a and 3b, that can be used to illuminate the pad or help reading during the night time. The front panel 61 is used to display a sign and the back panel 62 for other uses. The light operates using the solar batteries during the day time when the inside of the vehicle does not have enough light, or uses the solar charged storage battery to be used during the night time. By exposing the solar cells to the sunlight for certain period, the batteries are charged and provide an extended operation without sunlight. For instance, 30 minutes of sunlight can provide 3 hours of light in the night time.

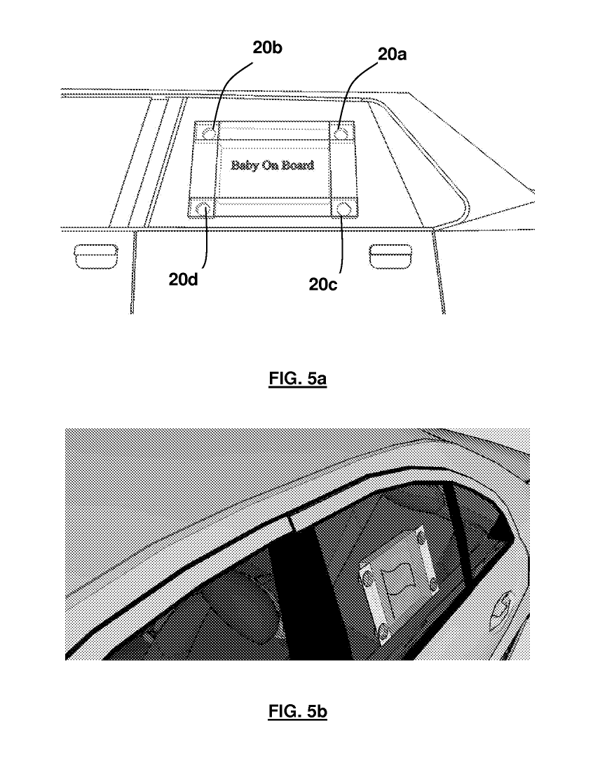

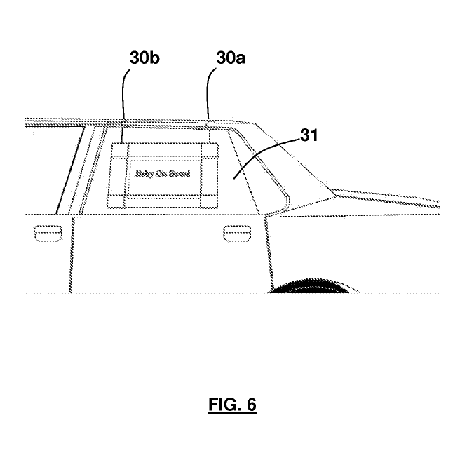

The device has attaching means to be attached to any of the windows of a vehicle or a building. FIG. 1 shows Velcro 15a, 15b as the attaching means, with one side sticking to the window and the other side sticking to the device, therefore, the device can be removed when not in use. FIG. 6 shows hooks 30a, 30b, as the attaching means to hook onto the side window 31 of a vehicle. FIGS. 2a and 2b show the display having apertures 18 to connect suction cups 20a-d, allowing suction cups to be attached to the window as shown in FIGS. 5a and 5b.

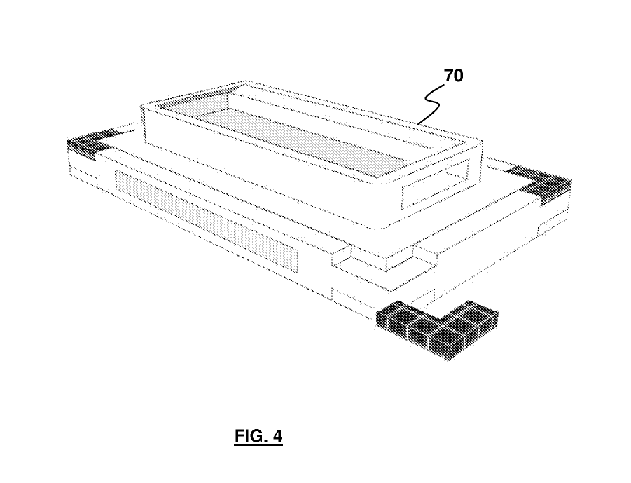

Another embodiment of the same invention has an air freshener holder on its back side as illustrated in FIG. 4.

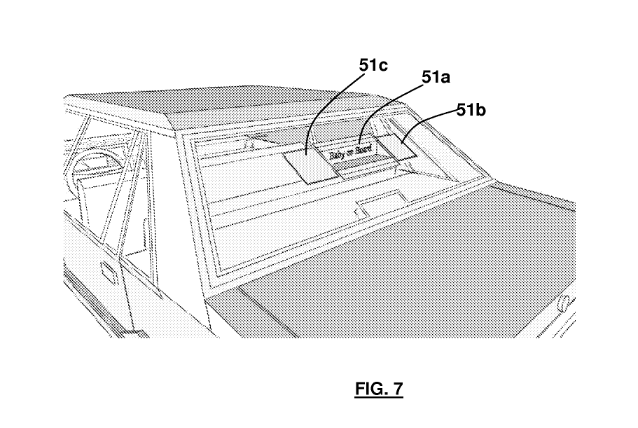

Device can also be used as a shade for the passengers. One embodiment of the device shown in FIG. 7 is an expandable unit with foldable screens. The embodiment shown in FIG. 5 has 3 screens, 51a, 51b, and 51c. Each may have its own image/expression or a part of an image/expression to form a whole image/expression. The expandable screen will allow easy storage of the unit when not in use. Such a screen can be adapted to cover a substantial part of a window of a vehicle and therefore act as a window shade. Such windows shades are commonly used to protect children in the car. The display side of the shade may display messages, such a “BABY ON BOARD”.

The device may have display units on both side, in which both the front and the back side of the device can display images. These images can be independent. The back side of the device, which is towards the interior, can display images of interest to the people inside. For instance, if there is a child on board of a vehicle, various images may flash to keep a child amused.

What is claimed is:

1. A solar powered and stand alone and mountable digital display device comprising:
a. a board having a front side, a back side, and plurality of sides;
b. said front having a display screen;
c. a digital memory unit for storing digital data;
d. said display screen adapted to display said stored digital data;
e. control circuitry coupled to the display screen for turning the display on and off and operating the images in continuous or flashing modes;
f. said board having solar batteries;
g. said board having a storage battery to store the electrical energy generated by said solar battery; and
h. said board having means to attach on a window, whereby various digital data, comprising of digital images, logos, expressions, announcements, messages, advertisement, and pictures can be displayed on the window.

2. The digital display device of claim 1, having flashing image mode.

3. The digital display device of claim 1, having two sided display screen.

4. The digital display device of claim 1, wherein the interface is adapted to receive image data from portable memory device.

5. The digital display device of claim 1, further comprising an operating system stored in the memory for permitting a user to interact with the display device.

6. The digital display device of claim 5, wherein the operating system stored in the memory permits the user to select from a plurality of images stored therein to display on the screen.

7. The digital display device of claim 1, where said means to attach the display device on a window comprises a set of Velcros.

8. The digital display device of claim 1, where said means to attach the display device on a window comprises a set of suction cups.

9. The digital display device of claim 1, where said means to attach the display device on a window comprises a set of hooks to be hooked on a vehicle window.

10. The digital display device of claim 1, further comprising a note pad attached to said back side of the board.

11. The digital display device of claim 1, further comprising a white board attached to said back side of the board.

12. The digital display device of claim 1, further comprising a pocket attached to said back side of the board to hold a GPS device.

13. The digital display device of claim 1, further comprising a reading light attached to said back side of the board.

14. The digital display device of claim 1, further comprising an air freshener holder attached to said back side of the board.
